(19) United States
(12) Patent Application Publication
(10) Pub. No.: US 2014/0314241 A1
(43) Pub. Date: Oct. 23, 2014

(54) FREQUENCY DOMAIN ACTIVE NOISE CANCELLATION SYSTEM AND METHOD

(71) Applicant: VOR Data Systems, Inc., San Diego, CA (US)

(72) Inventor: John Penhune, La Jolla, CA (US)

(73) Assignee: VOR Data Systems, Inc., San Diego, CA (US)

(21) Appl. No.: 13/957,389

(22) Filed: Aug. 1, 2013

Related U.S. Application Data
(60) Provisional application No. 61/814,477, filed on Apr. 22, 2013.

(51) Int. Cl. G10K 11/175

(52) U.S. Cl. CPC G10K 11/175
USPC 381/71.1

(57) ABSTRACT

A frequency domain active noise cancellation system and method are provided that achieves superior active reduction of offending noise sources. The frequency-domain active noise cancellation identifies and cancels one or more of the strongest relatively narrow frequency bands in the power spectra of the offending sound sources.

### PRIORITY CLAIM/RELATED APPLICATION

This application claims the benefit under 35 USC 119(e) and 120 to U.S. Provisional Patent Application Ser. No. 61/814,477, filed on Apr. 22, 2013 and entitled “A Frequency-domain Method of Obtaining Superior Active Reduction of Offending Noise Sources”, the entirety of which is incorporated herein by reference.

### FIELD

The disclosure relates generally active noise cancellation and in particular to a frequency domain technique for active noise cancellation.

### BACKGROUND

There are many situations in which there are noise sources that are loud enough to distract or annoy a user, make it hard for a user to concentrate or hard for a user to sleep (collectively “offending noise sources”.) An example may be a yacht that has a number of generators, engines, compressors, etc. that may be near a passenger cabin and thus are offending noise sources. It is desirable to be able to reduce the sound levels of the offending noise sources using active noise cancellation.

One active noise cancellation technique is to use a time domain method in which the processing and generation of the active noise cancellation signal occurs in the time domain. The limitation of the time domain method is that the time domain method must typically estimate hundreds of time sample weights so that the statistical estimation accuracy of the weight estimates is far lower than the accuracy of the relatively few amplitude and phase estimates employed in the frequency domain method. Furthermore, the time domain method takes a longer time to complete since there are more estimates and requires more robust hardware to perform the estimates and then calculate the active noise cancellation signal.

As shown in FIG. 1-FIG. 5, the dominant power in many offending sound sources is concentrated in a few relatively narrow frequency bands. For example, FIG. 1 shows the power spectrum of sound from a truck powered by a diesel engine that has narrow frequency bands at 24, 48, 71, 95, 118, 142 and 166 Hz. FIG. 2 shows the power spectrum of sound from a bus powered by a diesel engine that has narrow frequency bands at 40, 80, 122, 163 and 241 Hz. FIG. 3 shows the power spectrum of sound from an industrial fan that has narrow frequency bands at 11, 28, 45, 67, 92, 149 and 291 Hz. FIG. 4 shows the power spectrum of sound from the HVAC system in a hospital medical examination room that has narrow frequency bands at 144, 205, 221, 254 and 385 Hz. FIG. 5 shows the power spectrum of sound from a helicopter that has narrow frequency bands at 13, 26, 38, 51, 64, 83, 165 and 248 Hz.

Existing time-domain noise cancellation methods waste statistical estimation power and computational efficiency by trying to cancel sound at frequencies between the sound peaks in FIGS. 1-5 at relatively isolated frequencies. This results in these time-domain systems having poorer noise cancellation performance than systems using other techniques. Thus, it is desirable to provide another active noise cancellation technique that provides better performance that these time domain methods and it is to this end that the disclosure is directed.

### BRIEF DESCRIPTION OF THE DRAWINGS

FIG. 1 shows the power spectrum of sound from a truck powered by a diesel engine;

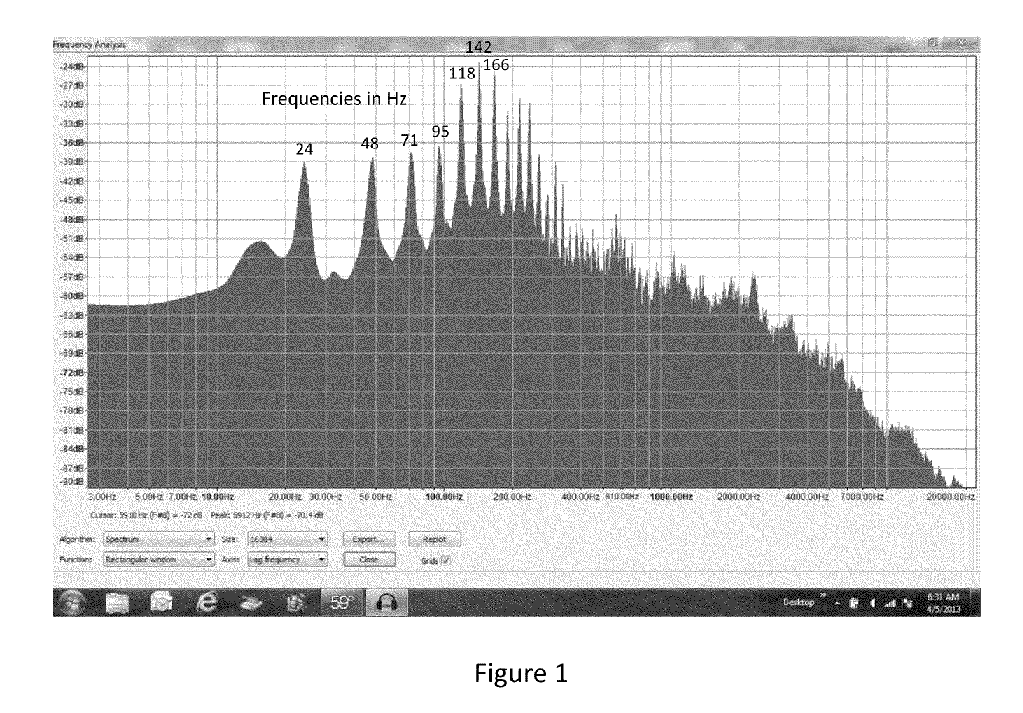

FIG. 2 shows the power spectrum of sound from a bus powered by a diesel engine;

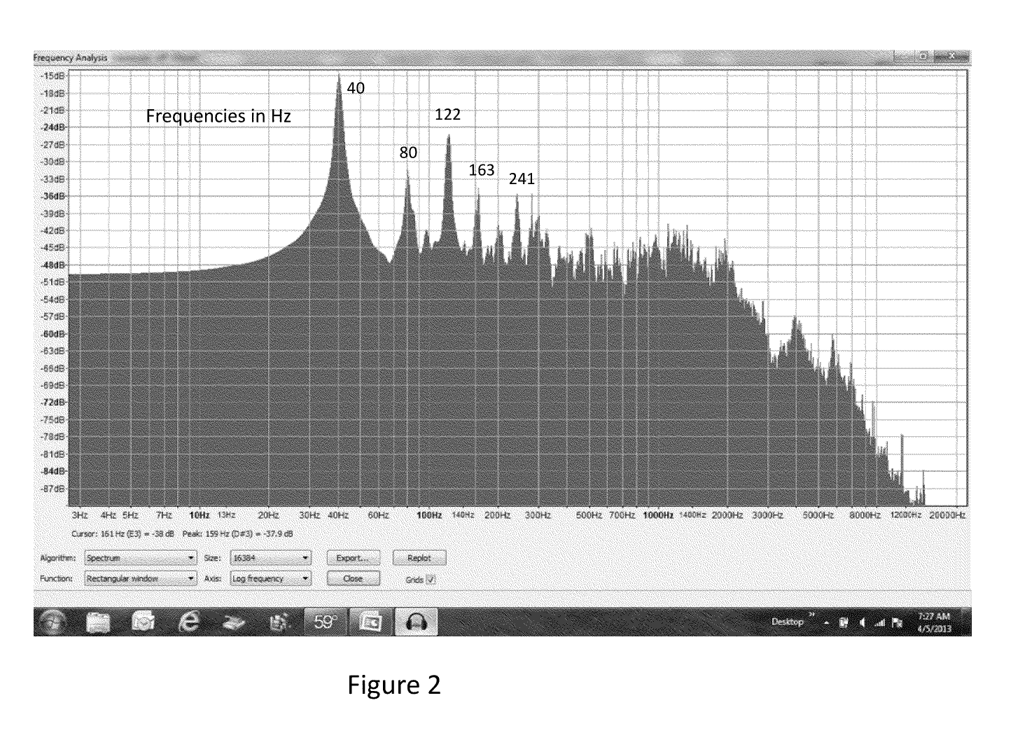

FIG. 3 shows the power spectrum of sound from an industrial fan;

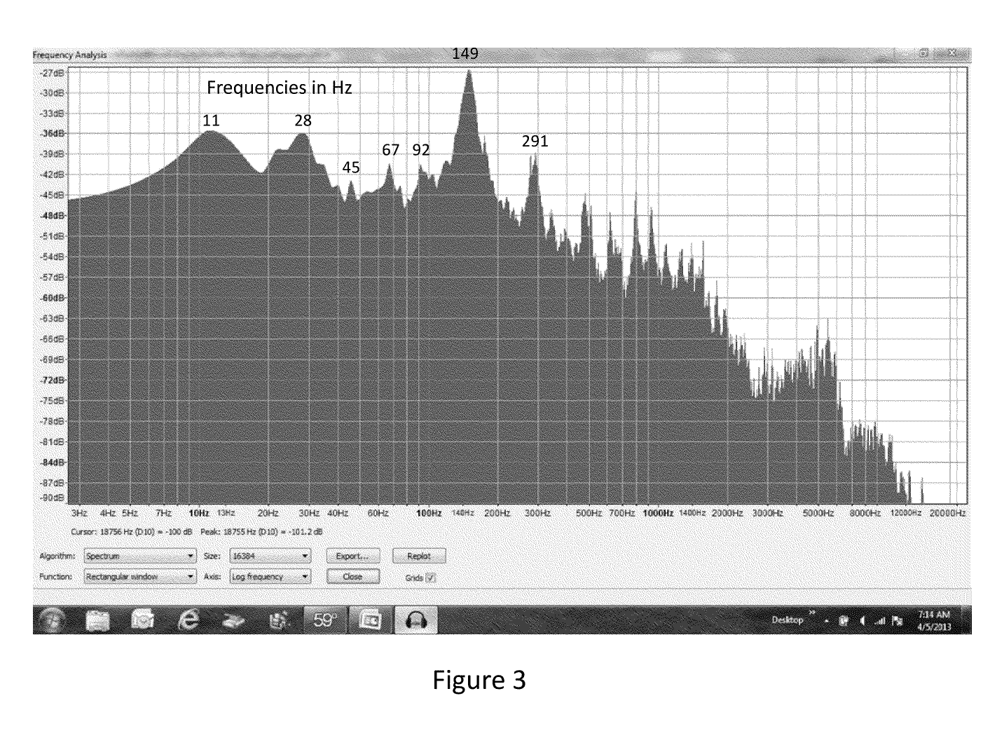

FIG. 4 shows the power spectrum of sound from the HVAC system in a hospital medical examination room;

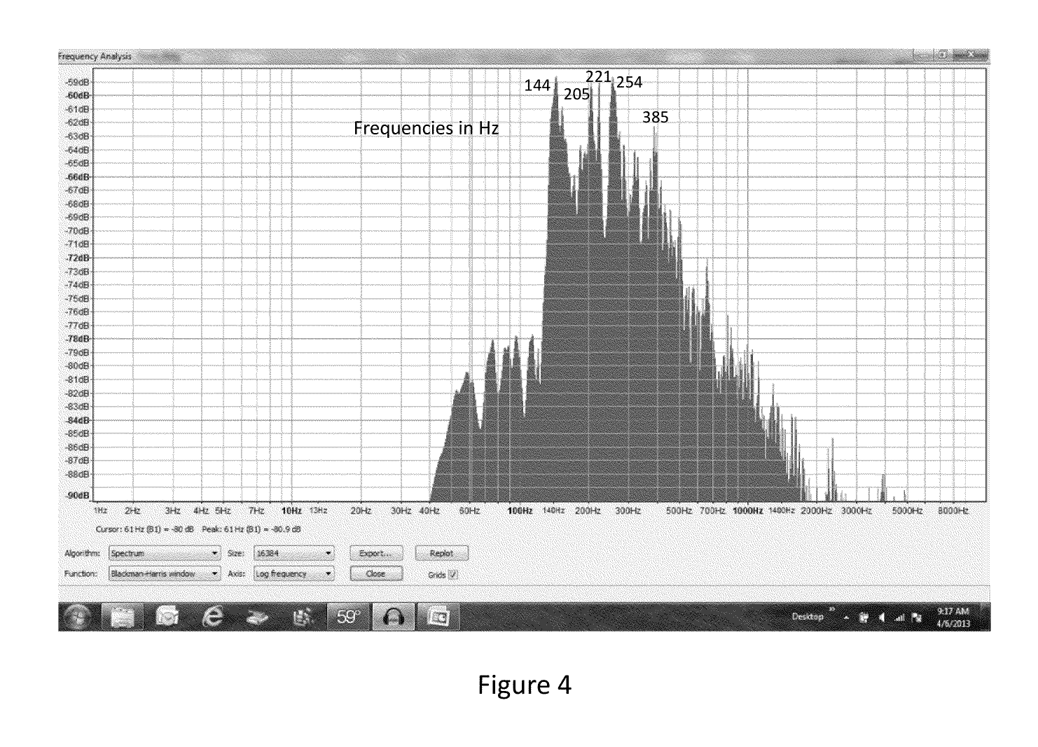

FIG. 5 shows the power spectrum of sound from a helicopter;

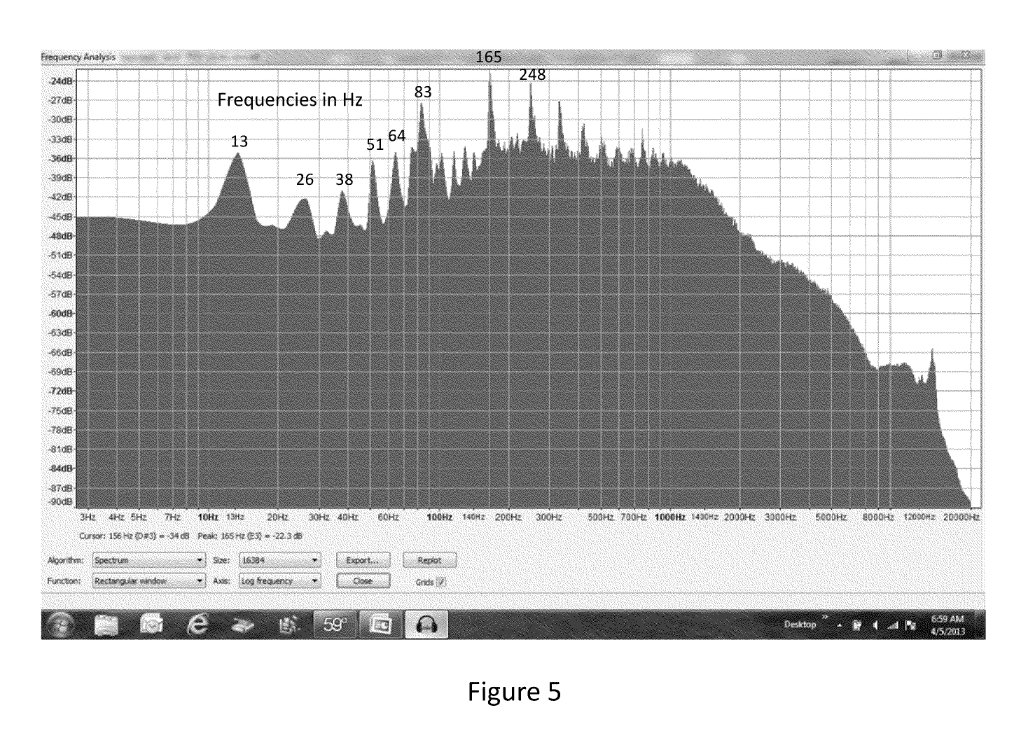

FIG. 6 illustrates several embodiments of an active noise cancellation system;

FIG. 7 illustrates an implementation of the active noise cancellation system;

FIG. 8 illustrates more details of the active noise cancellation engine that is part of the active noise cancellation system;

FIG. 9 illustrates a method for frequency domain active noise cancellation;

FIG. 10 illustrates an implementation of the active noise cancellation system in a yacht stateroom;

FIG. 11 shows the power spectrum of 5.5 seconds of sound from a diesel-powered bus;

FIG. 12 shows a blow-up of the power spectrum in FIG. 11 around the three strong lines; and

FIG. 13 shows noise reduction results of the frequency domain active noise cancellation system for the power spectrum of the diesel-powered bus.

### DETAILED DESCRIPTION OF ONE OR MORE EMBODIMENTS

The disclosure is particularly applicable to a frequency domain active noise cancellation system and method used to cancel noise from offending noise sources in a user inhabited area and it is in this context that the disclosure will be described. For example, for purposes of illustration of the frequency domain active noise cancellation system and method, a yacht stateroom installed frequency domain active noise cancellation system and method are described below. However, it will be appreciated that the frequency domain active noise cancellation system and method has greater utility since it also may be used to perform active noise cancellation at a noise source and may be used for various other implementations. For example, the frequency domain active noise cancellation system and method may be used for a noise cancellation system for hotel rooms, office buildings, hospitals, cabs and sleeping areas of trucks, interiors of propeller driven aircraft and helicopters, interiors of boats powered by large diesel engines or using large diesel generators, construction sites, oil and natural gas drilling rigs, mining operations, observation areas at gunnery ranges and/or any other implementation in which it would be desirable to be able to perform active noise cancellation of offending noise sources.

The sound sources for which noise is being cancelled using the frequency domain active noise cancellation system and method may be various source sources. For example, the sound source may be a generator (that is gasoline or diesel powered), a truck (that is gasoline or diesel powered), a bus (that is gasoline or diesel powered), motor vehicles on streets or freeways, a diesel powered railroad locomotive, an industrial fan, a heating, ventilation and air conditioning (HVAC) system of a building, an airplane, a helicopter, a loudly playing band, a loudly playing sound system, a loudly playing TV set, a loud conversation, discharges of weapons of any other sound source for which it would be desirable to reduce/cancel the noise generated by that source.

As described above, typical noise cancellation systems, such as headphones, operate in the time domain by sampling the offending sound at a temporal rate sufficient to reproduce the highest frequencies of interest, typically at 40 kilohertz or greater sampling rates. Before beginning the process of estimating noise cancellation signals, these systems must collect data over many cycles of the lowest frequencies of interest, typically 60 Hz or lower. The result of these two requirements is that time domain systems typically must estimate many thousands of weights to cover the broad noise cancellation bands for which they are designed.

The frequency domain active noise cancellation system and method may provide superior performance in the reduction of offending noise sources over time domain systems. The frequency-domain system and method described below identify and then cancel one or more of the strongest relatively narrow frequency bands in the power spectra of the offending sound sources. For example, there may be only two or three frequency bands of interest and each band can be represented by a small number of frequencies so that the frequency domain methods disclosed herein only must estimate about 10 amplitudes and phases, hundreds of times less weights than are required by time-domain methods. Thus, the frequency-domain system and method may estimate far fewer quantities (perhaps three to five amplitudes and phases, for example) than time-domain methods. Since the frequency domain active noise cancellation system and method estimates fewer quantities, the statistical estimation accuracy of the weight estimates is higher than the time domain methods.

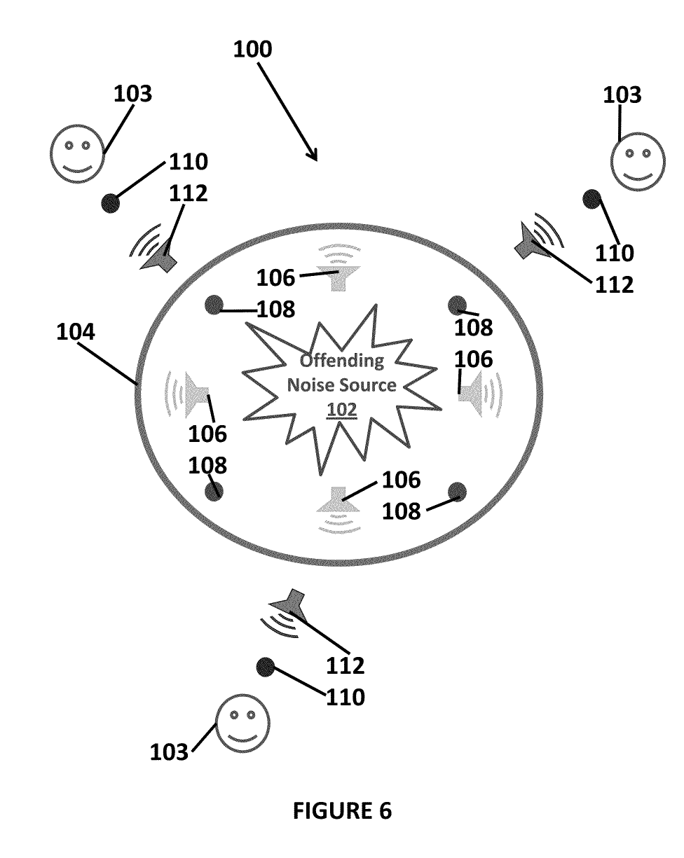

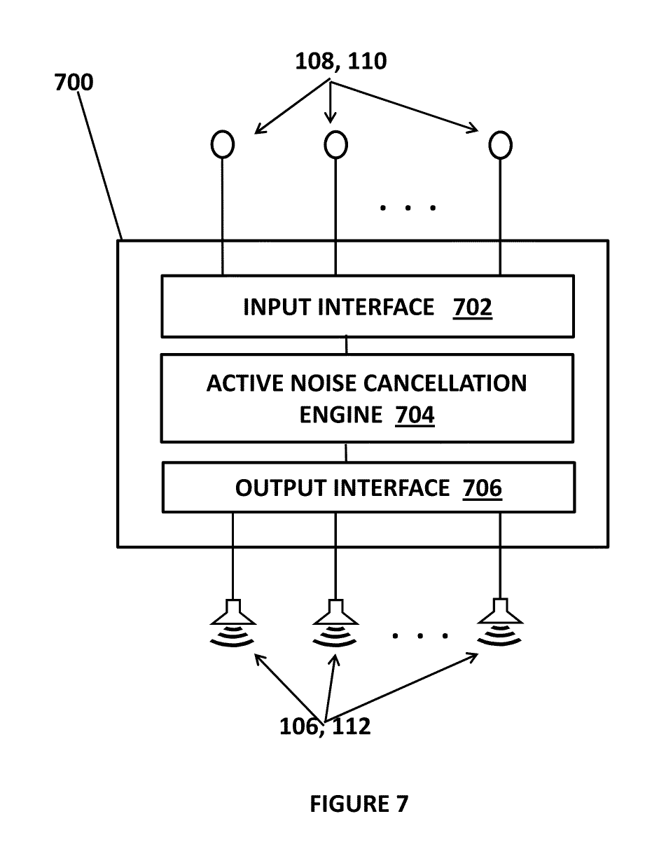

FIG. 6 illustrates several embodiments of an active noise cancellation system 100 to perform active noise cancellation for an offending noise source 102. The system 100 also may be used to perform active noise cancellation for a plurality of offending noise source 102 at the same time. The system may be used to cancel/reduce the noise from the offending noise source 102 directed to one or more users 103 and may have a passive sound barrier 104. The sounds barrier 104 may be made from massive sound deadening materials such as concrete blocks, faced with passive sound absorbing materials. In addition, active noise cancellation is provided by the speakers 106 powered by amplifiers driven by a frequency domain active noise cancellation engine 704 (shown in FIG. 7) that is part of an frequency domain active noise cancellation backend 700 that receives input signals from one or more sensors 108, 110 that may be adjacent the offending noise source and/or near the user 103. The sensors may measure the sound near the offending sound source or at one or more locations at which the noise reduction are desired. Each sensor may be a microphone, a motor sensor, an engine tachometer or an accelerometer measuring vibration or any other device can capture a noise level or noise level related data. The frequency domain active noise cancellation engine 704 (shown in FIG. 7) may also be coupled to one or more sound transducers 106, 112 that may be adjacent the offending noise source and/or near the user 103 that generate the active noise cancellation signals determined by the frequency domain active noise cancellation engine 704 using frequency domain techniques as described below. Each sound transducer may be a sound projection speaker or other sound transducer and each also may have an associated amplifier. Each sound transducer may be a speaker that is capable of reproducing the frequencies of the noise to be cancelled, have a well-behaved phase characteristic over the frequency bands to be reproduced, and be linear at the sound power levels required. In FIG. 6, the frequency domain active noise cancellation system may be used to reduce/cancel the offending noise at the location of each listener 103 using the sound transducer 112 adjacent each listener or may be used to reduce/cancel the offending noise at the location of offending noise source 102 using the one or more sound transducers 106 adjacent the offending noise source 102.

FIG. 7 illustrates an implementation of the frequency domain active noise cancellation system 700. The system 700 may have an input interface 702 that is connected to the one or more sensors 108, 110 and an output interface 706 that is connected to the one or more sound transducers 106, 112. Both the input and output interfaces 702, 706 are connected to the active noise cancellation engine 704. The input interface 702 may receive an electrical signal from each sensor (over a wired connection or wirelessly) and process that signal as needed so that it can be used by the frequency domain active noise cancellation engine 704 as described below. The output interface 706 may generate an electrical signal for each speaker that causes the speaker to generate an appropriate noise cancellation sound signal.

The input interface 702 may further comprise a typical A/D converter that converts the analog electrical signal for each sensor into a digital signal for each sensor and may also have a circuit or software that converts the digital signal into a digital signal in the frequency domain. For example, the input interface may perform a known fast Fourier transformation in hardware or software to convert each sensor signal into frequency domain sensor signals. Alternatively, the A/D converter and/or the frequency domain converter may be incorporated into the frequency domain active noise cancellation engine 704.

The output interface 706 may further comprise a circuit or software that converts the frequency domain estimated noise cancellation signals into a time domain digital signal and a typical D/A converter that converts the digital time domain noise cancellation signal for each sound transducer into an analog signal. In some embodiments in which a digital signal is sent wirelessly to each sound transducer, the D/A converter may be unused or removed from the system. The circuit or software that converts the frequency domain estimated noise cancellation signals into a time domain digital signal may perform a known inverse fast Fourier transformation in hardware or software. Alternatively, the D/A converter and/or the frequency domain converter may be incorporated into the frequency domain active noise cancellation engine 704.

The system 700 may be implemented in a combination of hardware and software to perform the frequency domain active noise cancellation. For example, the system 700 may be a separate hardware appliance or may be integrated into a larger system. Each of the input/output interface 702, 706 may be a hardware based interface, but may also incorporate software. The frequency domain active noise cancellation engine 704 may be implemented using a piece of hardware that executes a plurality of lines of computer code. For example, the frequency domain active noise cancellation engine 704 may be various types of processor, a digital signal processor, a hardware programmed device, a microcontroller, a central processing unit, a graphics processing unit (GPU) of a general purpose computer, a tablet device, or a smart phone and the like that has some memory to store the plurality of lines of computer code. The frequency domain active noise cancellation engine 704 may also be implemented as a programmed hardware device.

The frequency domain active noise cancellation engine 704 may be a real-time control system that determines the principal frequencies of the offending sound source. The system then determines the best amplitudes and phases of sounds that are transmitted near the location where noise reduction is desired such that the system transmissions cancel out the offending noise. Thus, the frequency-domain method described herein concentrates on the strongest relatively narrow frequency bands in the power spectra of the offending sound sources. The frequency-domain method has to estimate far fewer quantities (perhaps three to five amplitudes and phases) than time-domain methods that typically estimate hundreds of time sample weights. Because the time-domain methods estimate many more quantities, the statistical estimation accuracy of the weight estimates is far lower than the accuracy of the relatively few amplitude and phase estimates made by the frequency-domain method described herein. The frequency-domain method described herein has been demonstrated to give superior performance in an example case.

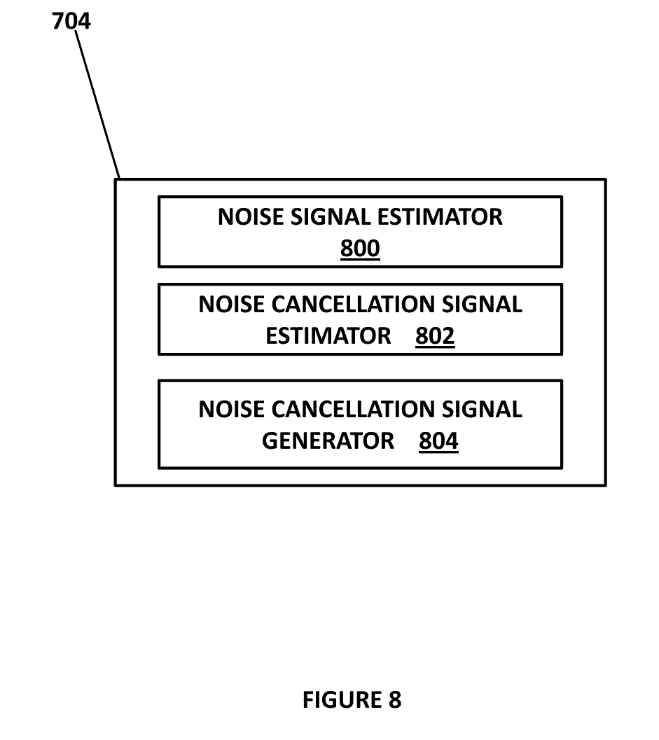

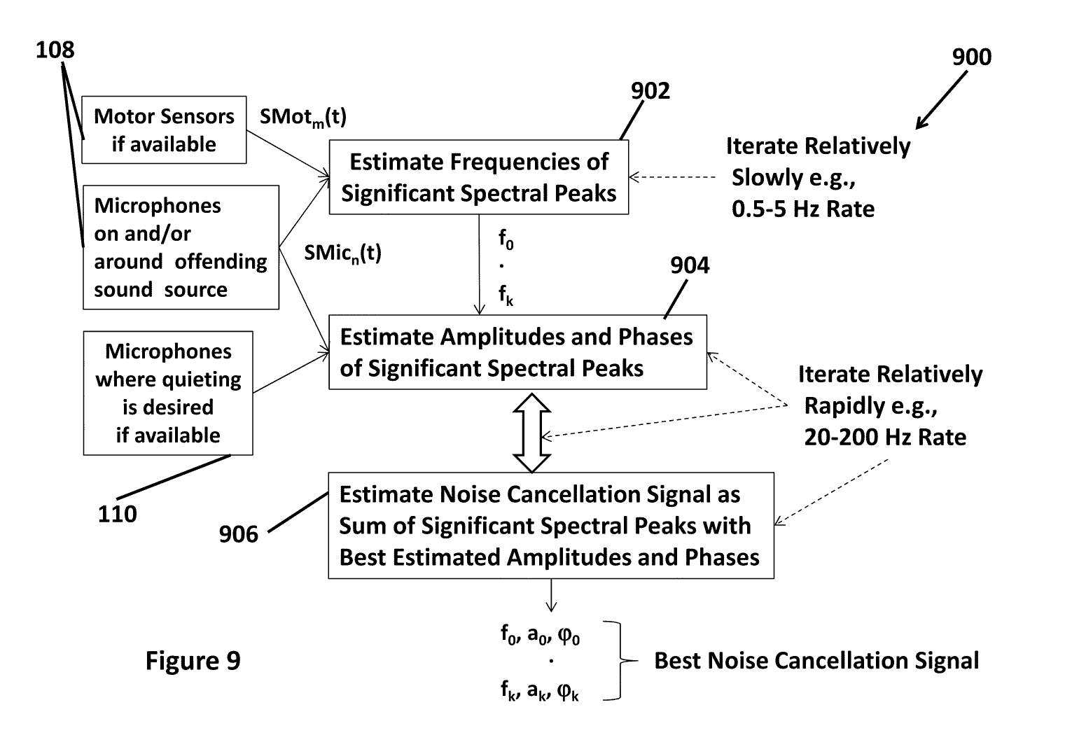

FIG. 8 illustrates more details of the frequency domain active noise cancellation engine 704 that is part of the active noise cancellation system and FIG. 9 illustrates a method 900 for frequency domain active noise cancellation that may be carried out, for example, by the frequency domain active noise cancellation engine 704 in FIG. 7. The frequency domain active noise cancellation engine 704 may have a noise signal estimator 800, a noise cancellation signal estimator 802 and a noise cancellation generator 804 and each of these components may be implemented in hardware or software or a combination of hardware and software as described above. In one embodiment, the three components in FIG. 8 may be implemented in a single piece of software that performs the frequency domain active noise cancellation processes described below.

As shown in FIG. 9, the sensors 108, 110 may sense the sound levels on and/or around the offending sound source and/or in the region where noise reduction is desired. The system may have other sensors (such as engine tachometers or accelerometers measuring vibration) that measure other data related to the noise level of the offending noise source. The measurement signals from the sensors may be converted into frequency domain digital signals as described above and then fed to the real-time frequency domain active noise cancellation engine 704 that implements the processes 902-906. The results of the computations performed by the real-time frequency domain active noise cancellation engine 704 may be a best one or more estimated noise cancellation signals that are fed through amplifiers to a plurality of sound projection speakers, loud speakers or other sound transducers near the region where reduction of the offending sound is desired. The frequency domain active noise cancellation engine 704 may be real-time because it processes the signals from the sensors in real time and estimates the one or more noise cancellation signals in real-time. The real-time frequency domain active noise cancellation engine 704 allows the frequency domain active noise cancellation engine 704 to adjust its noise cancellation signals in real-time as the characteristics of the noise from one or more offending noise sources may change over time, such as changing frequencies, increasing or decreasing in volume and the like.

As shown in FIG. 9, the signals from the sensors 108, 100 may be converted into digital frequency domain signals as described above and fed into the noise signal estimator 800 that analyzes the offending sound signals and estimates one or more principal frequencies (spectral peaks, such as f₀, . . . , fₖ) that contain the majority of the sound power of the offending sound signal 902. This process is performed in the frequency domain.

If the system is being used with multiple offending sound sources, the system estimates the frequency content of the offending sound sources frequency band by frequency band. Because the system is linear, the band-by-band cancellation signals may be weighted and added before being fed to the appropriate amplifiers and speakers. The weighting will depend on the locations of the sensors and speakers employed. In one embodiment, this process 902 may be repeated relatively slowly (e.g. at 0.5 Hz to 5 Hz), but rapidly enough to react to changes in the spectral content of the offending sound source (e.g. due to the driver stepping on the accelerator of a truck, or a fan or HVAC system turning on and off).

The results of the estimation process 902 (f₀, . . . , fₖ) may be fed into a second estimation process 904 (that may also be performed in one embodiment by the noise signal estimator 800) that estimates an amplitude and a phase of each of the one or more principle frequencies (f₀, . . . , fₖ) that carry most of the power of the offending sound source. This process is performed in the frequency domain.

Once the amplitudes and phases of the one or more principle frequencies is estimated, an amplitude and a phase of each of one or more noise cancellation signals to cancel/reduce the noise from the sound source may be estimated (906) for each speaker. The system may also have information about the location of each sound transducer that is being used to reduce/cancel the noise. The system may use that information about the location of each sound transducer, in part, to estimate the noise cancellation signal for each sound transducer that may be different depending on the location of each sound transducer. This process may be performed by the noise cancellation estimator 802 in one embodiment. These estimates may be a sum of the one or more principle frequencies with the best estimated amplitudes and phases.

The results of this process may be one or more best noise cancellation signals for each principle frequency in which each noise cancellation signal has a frequency, f, an amplitude a and a phase φ. For example, the system may generate an estimate of f₀, a₀, φ₀ for principle frequency f₀ and fₖ, aₖ, φₖ for principle frequency fₖ. The computations performed in processes 904, 906 may be repeated relatively rapidly (e.g. at a 20 Hz to 200 Hz rate) so that the best possible noise cancellation performance is obtained in the region where it is desired.

When one or more noise cancellation signals are estimated, the noise cancellation signal generator 804 may generate the appropriate noise cancellation signals for each sound transducer. Alternatively, each amplifier and sound transducer 106, 112 may generate the appropriate noise cancellation signals.

The processes shown in FIG. 9 (902, 904, 906) may be implemented using subroutines that execute repetitive tasks (e.g. taking FFTs, making optimum statistical estimates). Alternatively, these repetitive processes may be implemented as loops or other constructs in C, C++, or other programming languages. A combination of both implementation approaches may be employed.

In a typical installation of the noise cancellation system, microphones and other sensors 108 may be installed on, at, or near the offending sound source. For example, in quieting noise from a band in a hotel, microphones 108 may be installed around the band area with emphasis on locations such as walls, ceilings, and floors through which offending sounds are transmitted to areas desiring quite, such as sleeping rooms, conference rooms, dining areas, and reading areas. One or more microphones 110 also may be installed in the areas in which noise reduction is desired. The electrical signals from all the microphones/sensors 108, 110 may be sent by wires or wirelessly (e.g. by Wi-Fi) to one or more real-time frequency domain active noise cancellation systems 700 that perform the noise cancellation computations for each or a plurality of the spaces in which noise reduction is desired. The real-time frequency domain active noise cancellation system(s) 700 may compute the best noise cancellation signals for each of a plurality of loudspeakers located appropriately in the spaces where noise reduction is desired. The cancellation signals may be amplified by multichannel amplifiers and sent by wire to the noise cancellation sound transducers. Alternatively, digital cancellation signals could be sent wirelessly to speaker systems containing audio amplifiers. In most installations, additional sensors improve noise cancellation performance as do additional sound transducers in the spaces in which noise reduction is desired, particularly if these spaces are large.

The real-time frequency domain active noise cancellation system 700 may be implemented as a stand-alone unit that may be deployed in individual rooms with or without connections to sensors outside the rooms. The system can and usually will be built without any permanent microphone signal storage, so occupants of rooms need not worry about their conversations or activities being recorded. Now, a specific example of the installation of the system in a yacht statement is provided.

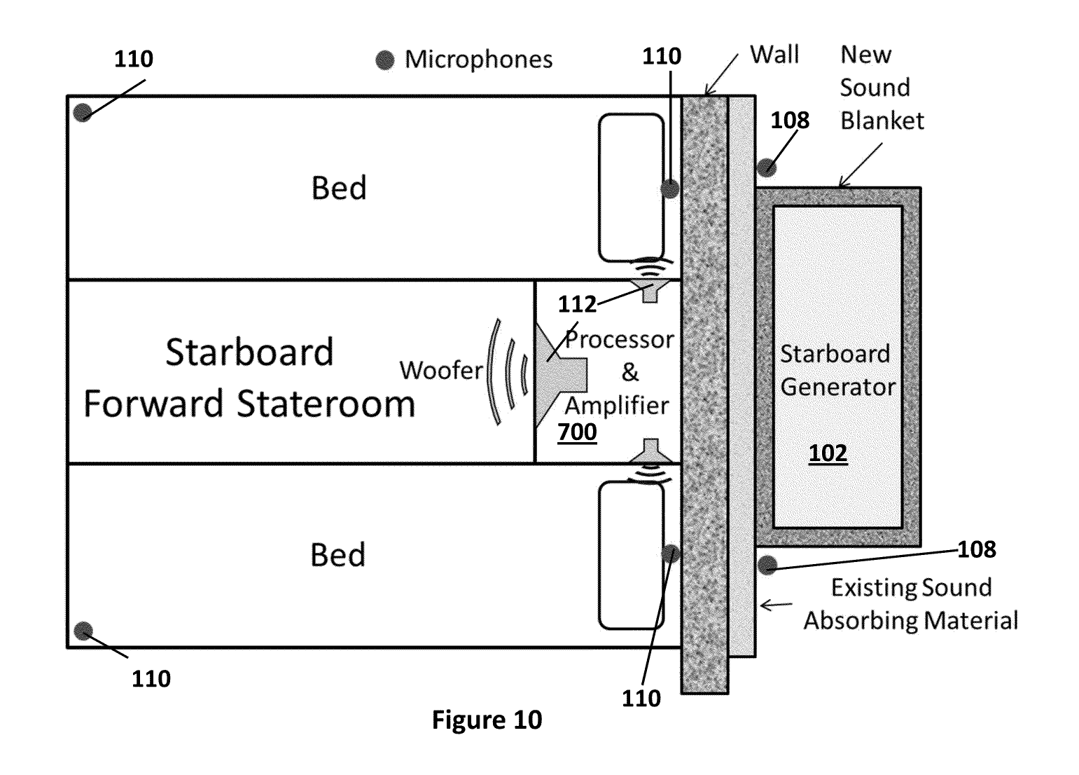

FIG. 10 illustrates an implementation of the active noise cancellation system in a yacht stateroom. The offending noise source 102 may be a generator in the yacht. The owner of the yacht may have taken other steps to reduce the noise from the generator including a sound blanket and sound absorbing material in the wall that separates the generator from a stateroom in which people want to be able to sleep/reside without the noise of the generator. The active noise cancellation system may have one or more sensors 108 near the generator to measure the noise of the generator. The data from these sensors 108 may be transmitted by wire or wirelessly to the frequency domain active noise cancellation system 700 that may be located, for example, in the stateroom. In this example, the frequency domain active noise cancellation system 700 may incorporate the sound transducers and amplifiers 112 that generate the noise cancellation signals. In this example, the stateroom may have one or more sensors 110 that measure the level of noise in the statement so that the frequency domain active noise cancellation system 700 may adjust in real-time to changing conditions.

A person or entity wanting to use the system 700 typically may undertake the following steps: (1) Record and analyze typical sounds from the offending sound source measured by microphones near and around the offending sound source to determine the level and spectral content of the offending sound source. (2) Measure and analyze the sound levels due to the offending source in the area(s) in which noise reduction is desired using microphones placed appropriately in these areas. (3) Plan the installation of the system including the microphones, the real-time control processor(s), the cancellation signal amplifiers, and the noise-cancellation loudspeakers. (4) Install and connect the system including all the elements described in (3) above. (5) Test the system to determine the noise reduction obtained. (6) Modify, adjust, maintain, and retest the system as appropriate.

In addition to the implementations of the real-time frequency domain active noise cancellation system 700 described above, the system 700 may be implemented in noise-cancellation headphones with performance superior to that of current headphones that employ time-domain processing. Also, the real-time frequency domain active noise cancellation system 700 might enable better ambient noise cancellation in smart phones.

For the yacht example shown in FIG. 10, the method for frequency domain active noise cancellation may estimate the sensor signals as follows:
Represent microphone signals Micₙ (tₙ) as an optimized sums of sinusoids;
Find fₘ, aₘ, φₘ such that:
   Σₘ(aₘ Sin(2π fₘ tₙ+φₘ)−Micₙ (tₙ) is minimized for spectral peaks in the frequency range of interest, e.g., ˜30 Hz to ˜200 Hz for yacht generator noise example in FIG. 10
Use a number of sinusoids, m, large enough that the residual is below the desired cancellation level, e.g., more than 15 dB down for yacht generator noise in this example.

For the yacht example shown in FIG. 10, the method for frequency domain active noise cancellation may then estimate the cancellation signals as follows:
Calculate cancellation sound signals, Canₙ (tₙ) as optimized sums of sinusoids with the same frequencies, fₘ, used to represent the microphone signals
Find aₖ, φₖ such that:
   Canₙ (tₙ)=Σₖ (aₖ Sin (2π fₘ tₙ+φₖ) and Micₙ (tₙ) is minimized for microphones near the user, e.g., the microphones near the pillows on the beds in the forward starboard cabin in the example in FIG. 10.

Example of Test Results of the System

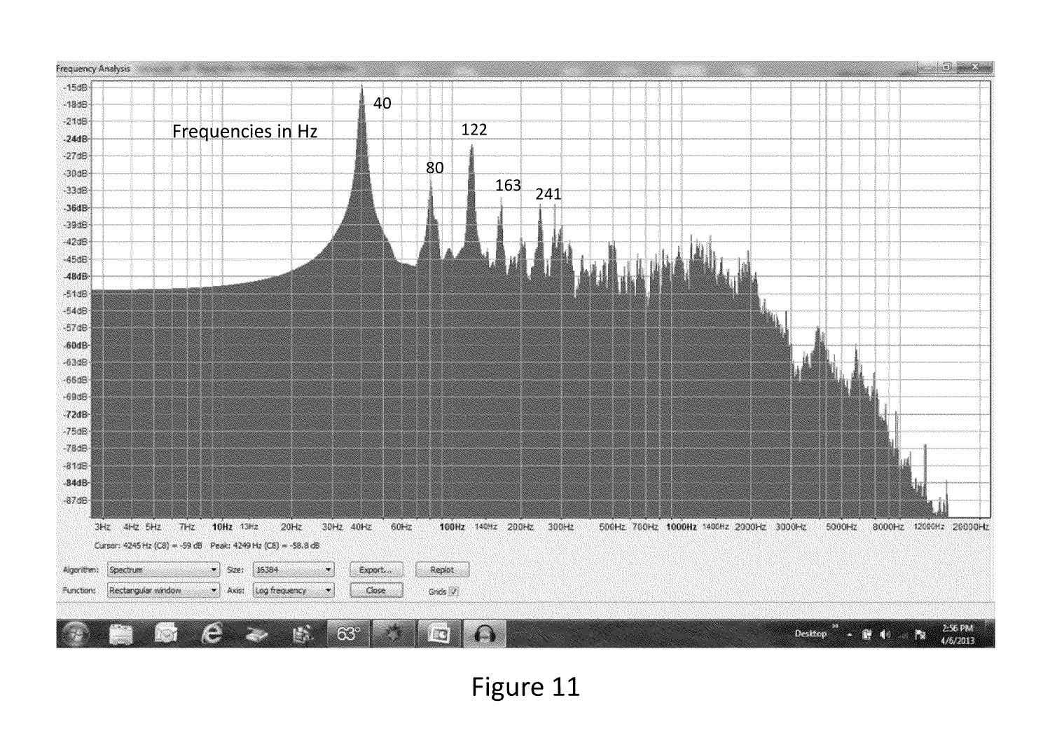

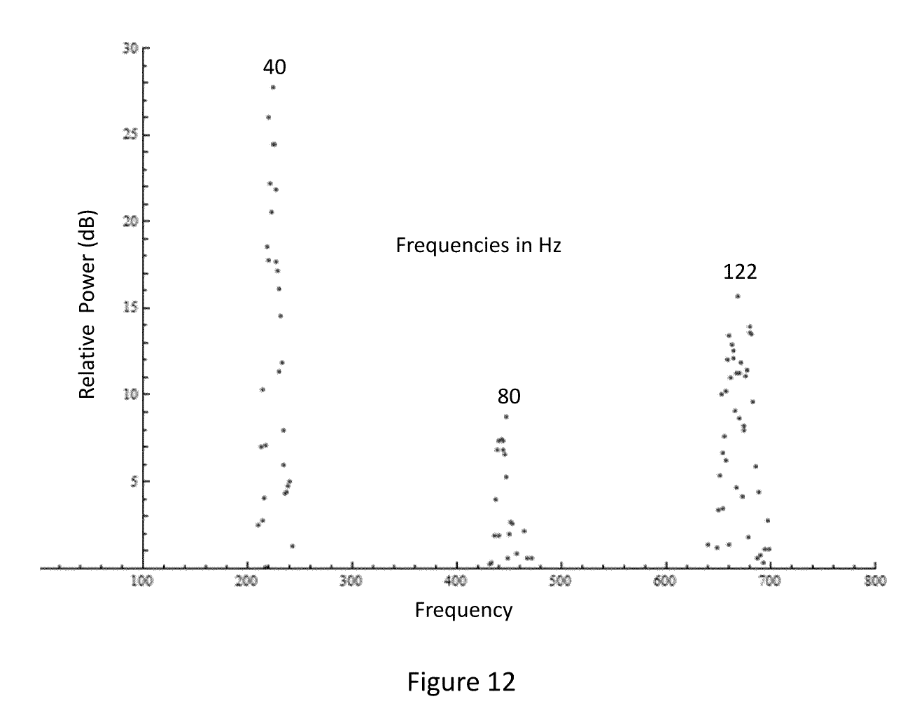

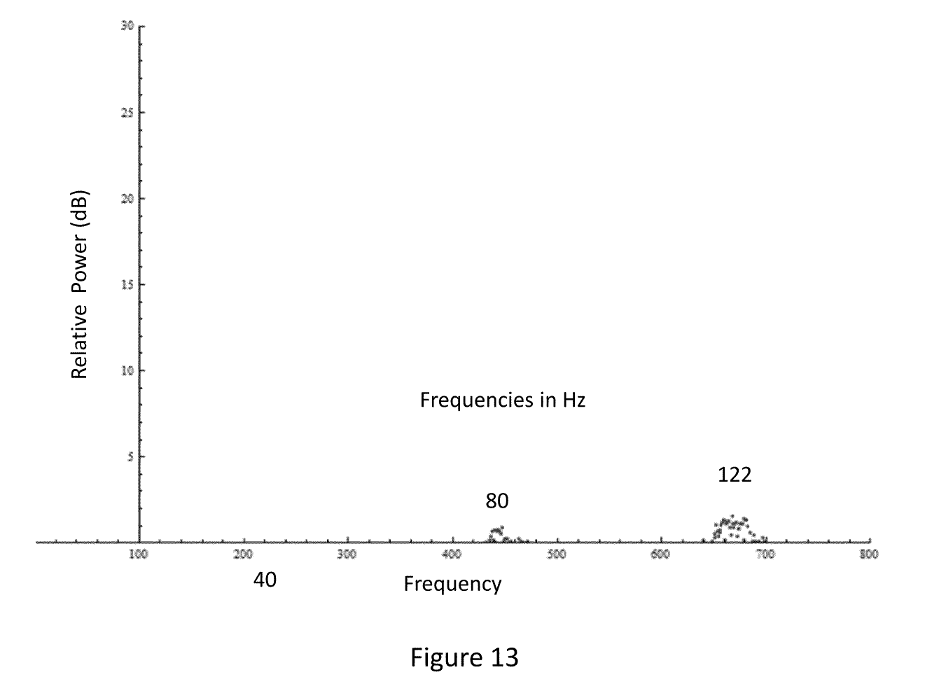

FIG. 11 shows the power spectrum of 5.5 seconds of sound from a diesel-powered bus. The three strongest peaks are located at 40 Hz, 80 Hz, and 122 Hz are responsible for most of the noise power. FIG. 12 shows a blow-up of the power spectrum in FIG. 11 around the three strong frequencies of 40, 80 and 122 Hz. Using the real-time frequency domain active noise cancellation system 700 applied to the strong frequencies shown in FIG. 12, the resulting noise reduction results shown in FIG. 13. Specifically, the spectral line at 40 Hz was reduced by about 30 dB, the line at 80 Hz was reduced by about 8 dB, and the line at 122 Hz was reduced by about 14 dB. The actual performance achieved in installed versions of the frequency-domain system will vary from case to case depending on the nature of the offending noise source and other factors.

While the foregoing has been with reference to a particular embodiment of the invention, it will be appreciated by those skilled in the art that changes in this embodiment may be made without departing from the principles and spirit of the disclosure, the scope of which is defined by the appended claims.

1. An active noise cancellation system, comprising:
one or more sensors that measure a sound source;
an active noise cancellation system connected to the one or more sensors, the active noise cancellation system having an estimator that estimates, in a frequency domain, one or more spectral peaks of the sound source based on the spectrum of the measured sound and a generator that generates a noise cancellation signal that cancels the one or more spectral peaks of the sound source; and
one or more sound transducers that generate the noise cancellation sound that cancels the one or more spectral peaks of the sound source.

2. The system of claim 1, wherein the estimator estimates an amplitude and a phase for each spectral peak.

3. The system of claim 2, wherein the generator estimates the noise cancellation signal as a weighted sum of the amplitudes and phases of the one or more spectral peaks.

4. The system of claim 1, wherein each of the one or more sensors is one of a microphone, a motor sensor, a vibration sensor and an accelerometer.

5. The system of claim 1, wherein the one or more sound transducers direct the noise cancellation signal towards a user outside of a passive a sound barrier.

6. The system of claim 1, wherein the one or more sound transducers are installed in a user inhabited area and the one or more sound transducers direct the noise cancellation signal into the user inhabited area.

7. The system of claim 1, wherein the sound source is one of a generator, a truck, a bus, a motor vehicle, a railroad locomotive, an industrial fan, a HVAC system, an airplane, a helicopter, noisy equipment on an oil or gas drilling rig, a loudly playing band, a loudly playing sound system, a loudly playing TV set, a loud conversation and a discharge of a weapon.

8. The system of claim 1 further comprising a processing unit that executes a plurality of instructions that implement the estimator and the generator.

9. The system of claim 8, wherein the processing unit is one of a central processing unit and a graphics processing unit.

10. The system of claim 8, wherein the processing unit is part of one of a general purpose computer, a tablet device and a smart phone.

11. A method for noise cancellation, comprising:
receiving, from one or more sensors, one or more measurements of a sound source;
determining, in a frequency domain, one or more spectral peaks of the sound source based on the spectrum of the sound source; and
determining, in a frequency domain, one or more noise cancellation signals based on the one or more spectral peaks of the sound source, wherein the one or more noise cancellation signals cancel the one or more spectral peaks of the sound source.

12. The method of claim 11 further comprising generating a noise cancellation signal that cancels the one or more spectral peaks of the sound source.

13. The method of claim 11, wherein determining one or more spectral peaks of the sound source further comprises determining an amplitude and a phase for each spectral peak.

14. The method of claim 13, wherein determining the one or more noise cancellation signals further comprises estimating the one or more noise cancellation signals as weighted sums of the amplitudes and phases of the one or more spectral peaks.

15. The method of claim 11 further comprising directing, using one or more sound transducers, one or more noise cancellation signals towards the user outside of a passive sound barrier.

16. The method of claim 11, wherein the sound source is one of a generator, a truck, a bus, a motor vehicle, a railroad locomotive, an industrial fan, a HVAC system, an airplane, a helicopter, noisy equipment on an oil or gas drilling rig, a loudly playing band, a loudly playing sound system, a loudly playing TV set, a loud conversation and a discharge of a weapon.

17. The method of claim 11, wherein determining one or more spectral peaks of the sound source further comprises iteratively estimating the one or more spectral peaks of the sound source at a slow frequency to account for slow changes in the spectral peaks.

18. The method of claim 17, wherein the slow frequency is 0.5 Hz to 5 Hz.

19. The method of claim 13, wherein determining the weight applied to the amplitude and a phase for each spectral peak to produce the cancellation signal further comprises iteratively estimating the weight applied to the amplitude and a phase for each spectral peak at a fast frequency.

20. The method of claim 19, wherein the fast frequency is 20 Hz to 200 Hz.

21. An active noise cancellation apparatus, comprising:
an interface to one or more sensors, the interface receiving a measurement of a sound from a sound source;
an estimator, coupled to the interface, that estimates, in a frequency domain, one or more spectral peaks of the sound source based on the spectrum of the measured sound; and
wherein the estimator also estimates, in a frequency domain, one or more noise cancellations signals based on the one or more spectral peaks of the sound source.

22. The apparatus of claim 21 further comprising a generator, coupled to the estimator that generates, in the frequency domain, a noise cancellation signal that cancels the one or more spectral peaks of the sound source.

23. The apparatus of claim 21, wherein the estimator estimates an amplitude and a phase for each spectral peak.

24. The apparatus of claim 21, wherein the sound source is one of a generator, a truck, a bus, a motor vehicle, a railroad locomotive, an industrial fan, a HVAC apparatus, an airplane, a helicopter, noisy equipment on an oil or gas drilling rig, a loudly playing band, a loudly playing sound apparatus, a loudly playing TV set, a loud conversation and a discharge of a weapon.

25. The apparatus of claim 21 further comprising a processing unit that executes a plurality of instructions that implement the estimator and the generator.

26. The apparatus of claim 25, wherein the processing unit is one of a central processing unit and a graphics processing unit.

27. The apparatus of claim 25, wherein the processing unit is part of one of a general purpose computer, a tablet device and a smart phone.

28. An active noise cancellation apparatus, comprising:
a processor; and
a memory storing a plurality of instructions, one or more instructions estimating, in a frequency domain, one or more spectral peaks of a sound source based on a measured sound spectrum and a second one or more instructions estimating, in a frequency domain, one or more noise cancellations signals based on the one or more spectral peaks of the sound source.

29. The apparatus of claim 28 further comprising one or more instructions that generate, in the frequency domain, a noise cancellation signal that cancels the one or more spectral peaks of the sound source.

30. The apparatus of claim 28, wherein the processor is one of a central processing unit and a graphics processing unit.

31. The apparatus of claim 30, wherein the processing unit is part of one of a general purpose computer, a tablet device and a smart phone.
